(19) United States
(12) Patent Application Publication
(10) Pub. No.: US 2013/0083248 A1
(43) Pub. Date: Apr. 4, 2013

(54) ELECTRONIC APPARATUS AND VIDEO PROCESSING METHOD

(71) Applicant: Shingo Suzuki, Akishima-shi (JP)

(72) Inventor: Shingo Suzuki, Akishima-shi (JP)

(73) Assignee: Kabushiki Kaisha Toshiba, Tokyo (JP)

(21) Appl. No.: 13/569,070

(22) Filed: Aug. 7, 2012

(30) Foreign Application Priority Data
Sep. 30, 2011 (JP) 2011-217002

(51) Int. Cl. H04N 5/52

(52) U.S. Cl. 348/678; 348/E05.115

(57) ABSTRACT

According to one embodiment, an electronic apparatus includes a block feature amount calculator, a local contrast correction curve generator and a contrast correction module. The block feature amount calculator divides pixels in a video frame into blocks, and calculates feature amounts corresponding to the blocks using luminance values of pixels in each of the blocks. The local contrast correction curve generator generates local contrast correction curves corresponding to the blocks using the feature amounts. The contrast correction module generates a corrected video frame using the local contrast correction curves.

### CROSS-REFERENCE TO RELATED APPLICATIONS

This application is based upon and claims the benefit of priority from prior Japanese Patent Application No. 2011-217002, filed Sep. 30, 2011, the entire contents of which are incorporated herein by reference.

### FIELD

Embodiments described herein relate generally to an electronic apparatus which correct contrast of video, and a video processing method applied to the electronic apparatus.

### BACKGROUND

In recent years, various electronic apparatuses such as personal computers, PDAs, cellular phones, and smartphones have prevailed. Such electronic apparatus has, for example, a function of playing back video.

Video images to be played back often undergo processing for enhancing image quality (for example, sharpening processing, tone correction processing, and the like). For example, in the tone correction processing, the contrast of an image is corrected according to a luminance histogram based on luminance signal components of the image. By enhancing the contrast of the image by the correction, the user can appreciate a crisp image with presence.

However, the tone correction processing based on the luminance histogram often impairs image quality. For example, in a flat region in which luminance values change smoothly in a video frame, pseudo-edges like contours may be generated as a result of the contrast enhancement. Assuming that a flat region in which luminance values change smoothly is converted into a region including pseudo-edges, even when another region is converted into a crisp image, the user may feel unnatural about a displayed image.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing the appearance of an electronic apparatus according to an embodiment.

FIG. 2 is an exemplary block diagram showing the system arrangement of the electronic apparatus according to the embodiment.

FIG. 3 is an exemplary block diagram for explaining an example of the functional arrangement of a video processing program executed by the electronic apparatus according to the embodiment.

FIG. 4 is an exemplary graph showing an example of a global contrast correction curve generated by the electronic apparatus according to the embodiment.

FIG. 5 is an exemplary graph showing an example of a pixel frequency function used to generate the global contrast correction curve shown in FIG. 4.

FIG. 6 is an exemplary graph showing another example of the pixel frequency function used to generate the global contrast correction curve shown in FIG. 4.

FIG. 7 is an exemplary view for explaining feature amounts of pixel blocks calculated by the electronic apparatus according to the embodiment.

FIG. 8 is an exemplary graph showing an example of an amplitude used in a local contrast correction curve generated by the electronic apparatus according to the embodiment.

FIG. 9 is an exemplary graph showing an example of the local contrast correction curve generated by the electronic apparatus according to the embodiment.

FIG. 10 is an exemplary view for explaining image contrast correction by the electronic apparatus according to the embodiment.

FIG. 11 is an exemplary flowchart showing an example of the procedure of contrast correction processing executed by the electronic apparatus according to the embodiment.

### DETAILED DESCRIPTION

Various embodiments will be described hereinafter with reference to the accompanying drawings.

In general, according to one embodiment, an electronic apparatus includes a block feature amount calculator, a local contrast correction curve generator, and a contrast correction module. The block feature amount calculator divides pixels in a video frame into blocks, and calculates block feature amounts corresponding to the blocks using luminance values of pixels in each of the blocks. The local contrast correction curve generator generates local contrast correction curves corresponding to the blocks using the block feature amounts. The contrast correction module generates a corrected video frame by correcting luminance values of the pixels in the video frame using the generated local contrast correction curves.

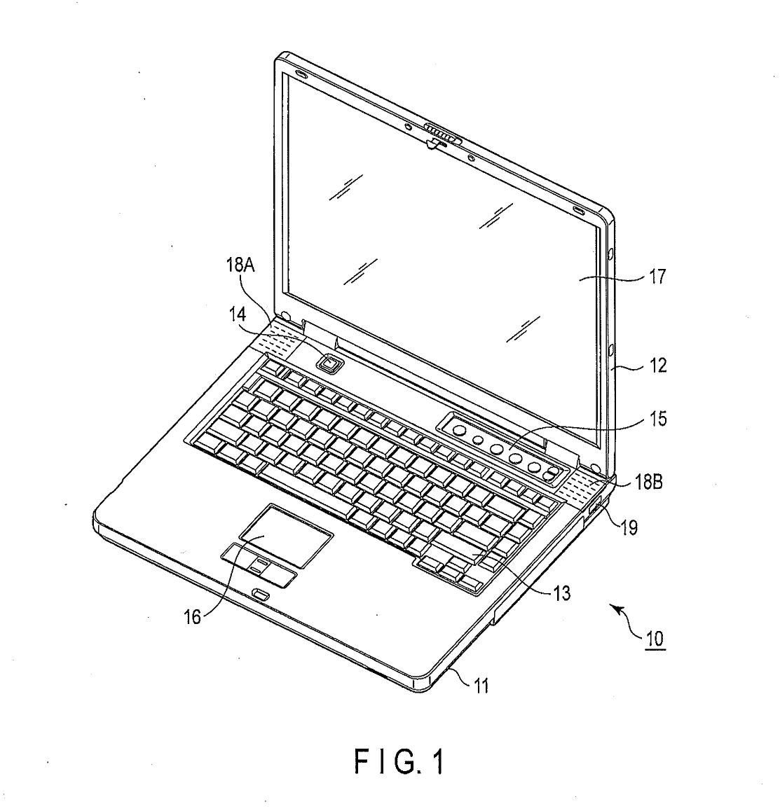

FIG. 1 is a perspective view showing the outer appearance of an electronic apparatus according to an embodiment. This electronic apparatus is implemented as, for example, a notebook type personal computer 10. As shown in FIG. 1, this computer 10 includes a computer main body 11 and display unit 12. A liquid crystal display (LCD) 17 is built in the display unit 12. The display unit 12 is attached to the computer main body 11 such that the display unit 12 is rotatable between an open position where the top surface of the computer main body 11 is exposed, and a closed position where the top surface of the computer main body 11 is covered.

The computer main body 11 has a thin box-shaped housing. A keyboard 13, a power button 14 for powering on/off the computer 10, an input operation panel 15, a pointing device such as a touch pad 16, and speakers 18A and 18B are disposed on the top surface of the housing of the computer main body 11. Various operation buttons are provided on the input operation panel 15.

A universal serial bus (USB) connector 19 used to connect a USB cable and USB device, which are conforming to, for example, the USB 2.0 standard, is arranged on the right side surface of the computer main body 11.

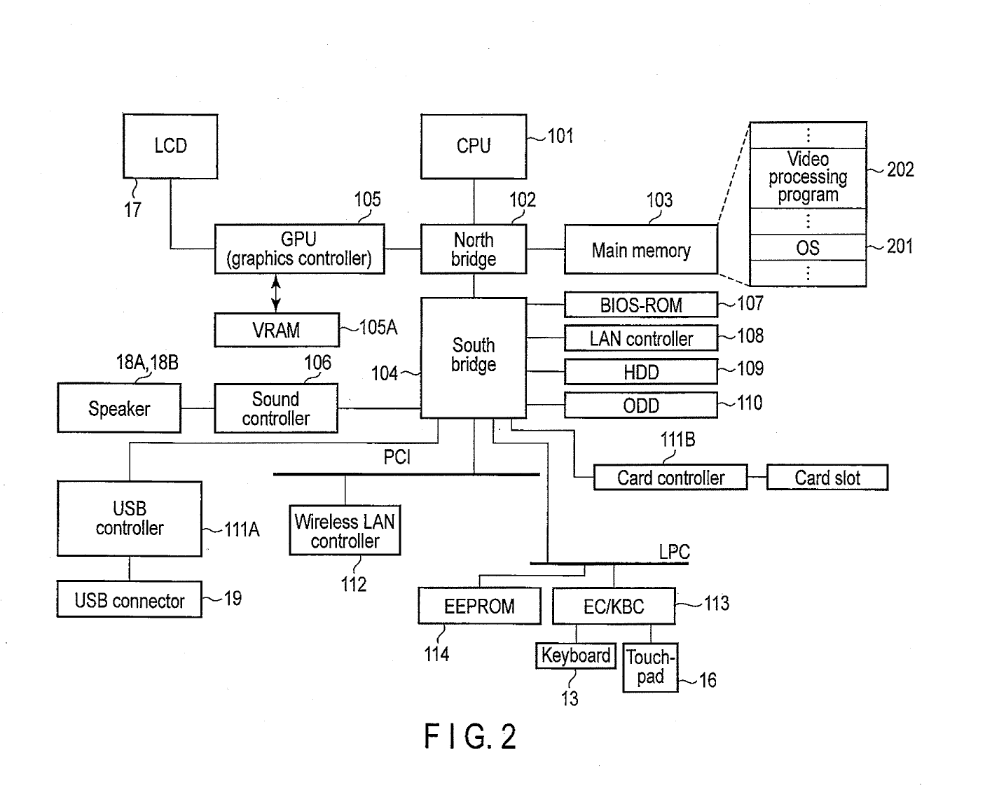

FIG. 2 shows the system arrangement of the computer 10.

As shown in FIG. 2, the computer 10 includes a central processing unit (CPU) 101, a north bridge 102, a main memory 103, a south bridge 104, a graphics processing unit (GPU) 105, a video random access memory (VRAM) 105A, a sound controller 106, a basic input/output system read-only memory (BIOS-ROM) 107, a local area network (LAN) controller 108, a hard disk drive (HDD) 109, an optical disc drive (ODD) 110, a USB controller 111A, a card controller 111B, a wireless LAN controller 112, an embedded controller/keyboard controller (EC/KBC) 113, an electrically erasable programmable ROM (EEPROM) 114, and the like.

The CPU 101 is a processor which controls the operations of the respective modules in the computer 10. The CPU 101 executes an operating system (OS) 201 and various application programs such as a video processing program 202, which are loaded from the HDD 109 onto the main memory 103. The video processing program 202 is software of playing back various digital content data (for example, video data) stored in the HDD 109 and the like. The video processing program 202 has an image quality correction function of correcting image quality (for example, contrast) of an image (a video frame) to be played back. For example, the video processing program 202 reproduces image data, and displays an image whose image quality is corrected on a screen (LCD 17).

The CPU 101 also executes a BIOS stored in the BIOS-ROM 107. The BIOS is a program for hardware control.

The north bridge 102 is a bridge device which connects between a local bus of the CPU 101 and the south bridge 104. The north bridge 102 includes a memory controller which access-controls the main memory 103. The north bridge 102 also has a function of executing communication with the GPU 105 via, for example, a serial bus conforming to the PCI EXPRESS standard.

The GPU 105 is a display controller which controls the LCD 17 used as a display monitor of the computer 10. A display signal generated by this GPU 105 is supplied to the LCD 17.

The south bridge 104 controls devices on a Peripheral Component Interconnect (PCI) bus and devices on a Low Pin Count (LPC) bus. The south bridge 104 includes an Integrated Drive Electronics (IDE) controller for controlling the HDD 109 and ODD 110. The south bridge 104 also has a function of communicating with the sound controller 106.

The sound controller 106 is a sound source device, and outputs audio data to be played back to the speakers 18A and 18B. The LAN controller 108 is a wired communication device which executes wired communication of, e.g. the IEEE 802.3 standard. The wireless LAN controller 112 is a wireless communication device which executes wireless communication of, e.g. the IEEE 802.11g standard. The USB controller 111A executes communication with an external device of, e.g. the USB 2.0 standard (which device is connected via the USB connector 19). The card controller 111B executes data read and write accesses to a memory card inserted in a card slot provided to the computer main body 11.

The EC/KBC 113 is a one-chip microcomputer in which an embedded controller for power management and a keyboard controller for controlling the keyboard (KB) 13 and touchpad 16 are integrated. The EC/KBC 113 has a function of powering on/off the computer 10 in accordance with the user's operation of the power button 14.

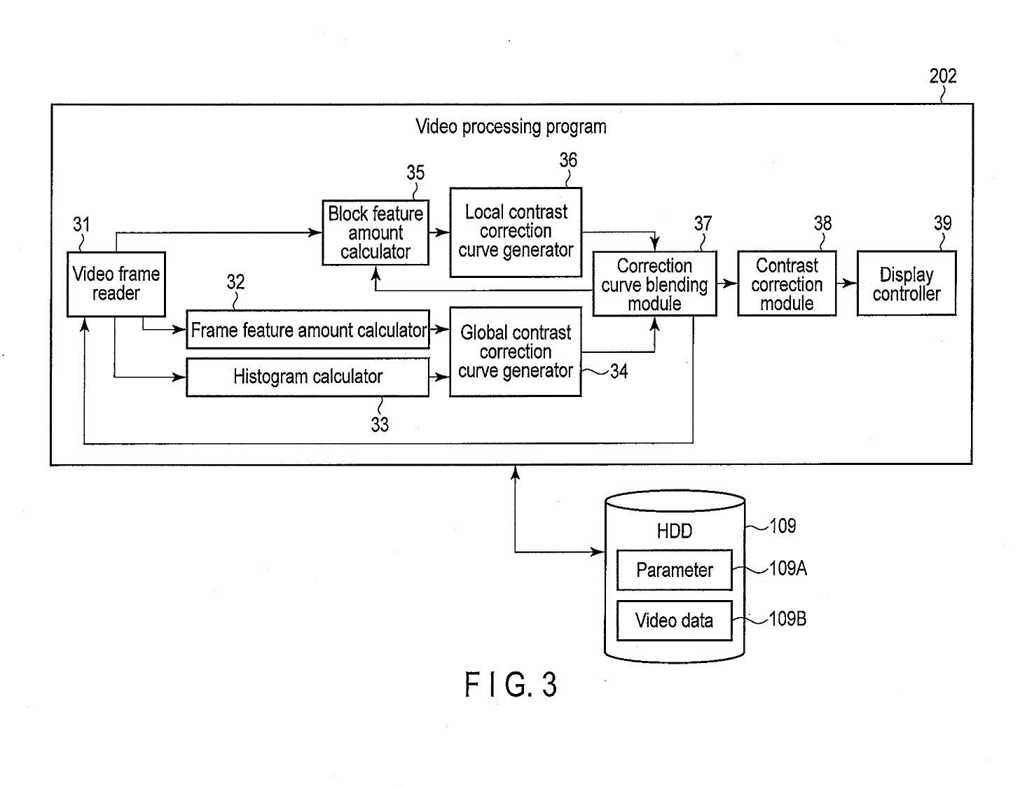

One functional configuration of the video processing program 202 will be described below with reference to FIG. 3. The video processing program 202 has a function of correcting image quality of an image (that is, a video frame) in video to be played back, as described above. The video processing program 202 corrects the contrast of an image using, for example, a contrast correction curve according to features of the image. The contrast correction curve is a function which indicates correspondence between input luminance values and output luminance values. More specifically, the video processing program 202 corrects contrasts of pixels included in a target frame using a global contrast correction curve (hereinafter also referred to as a frame contrast correction curve) which considers features of the target frame, and local contrast correction curves (hereinafter also referred to as block contrast correction curves) which consider features of blocks included in the target frame.

The video processing program 202 includes a video frame reader 31, a frame feature amount calculator 32, a histogram calculator 33, a global contrast correction curve generator 34, a block feature amount calculator 35, a local contrast correction curve generator 36, a correction curve blending module 37, a contrast correction module 38, and a display controller 39.

The video frame reader 31 reads video data 109B stored in the HDD 109 or the like, and sets a first video frame of video frames included in the video data as a target video frame. Each of the video frames in the video data is set as the target video frame in turn from the first frame. Note that the video frame reader 31 may read video data stored in a storage medium such as a DVD in place of the HDD 109. The video frame reader 31 may receive video data from another computer (server) via a network. The video frame reader 31 outputs the target video frame to the frame feature amount calculator 32, the histogram calculator 33, and the block feature amount calculator 35.

The frame feature amount calculator 32 calculates a frame average luminance value (average picture level) APL_{F} of pixels in the target video frame based on luminance values xᵢ of the pixels in the target video frame by:

$${APL}_{F} = \frac{1}{N} {\sum }_{i = 0}^{N} {x}_{i} ,$$

where N is the number of pixels in the target frame. The frame feature amount calculator 32 outputs the calculated frame average luminance value APL_{F} to the global contrast correction curve generator 34.

The histogram calculator 33 calculates a luminance histogram of pixels in the video target frame using luminance values of the pixels in the video target frame. The luminance histogram indicates the numbers of pixels for respective luminance levels of the video target frame. The histogram calculator 33 outputs the calculated luminance histogram to the global contrast correction curve generator 34.

The global contrast correction curve generator 34 generates a global contrast correction curve corresponding to the target frame using the frame average luminance value APL_{F} output from the frame feature amount calculator 32, the luminance histogram output from the histogram calculator 33, and parameters 109A stored in the HDD 109. More specifically, the global contrast correction curve generator 34 sets the frame average luminance value APL_{F} as an inflection point of a first correction curve specified by the parameters 109A. This first correction curve is an S-shaped curve to weaken contrasts of pixels with low luminance values and to strengthen contrasts of pixels with high luminance values. The global contrast correction curve generator 34 calculates a pixel frequency function based on the luminance histogram. Then, the global contrast correction curve generator 34 blends (α-blends) the first correction curve set with the frame average luminance value APL_{F} as the inflection point and the pixel frequency function at a predetermined ratio, thereby generating a global contrast correction curve. The global contrast correction curve generator 34 outputs the generated global contrast correction curve to the correction curve blending module 37.

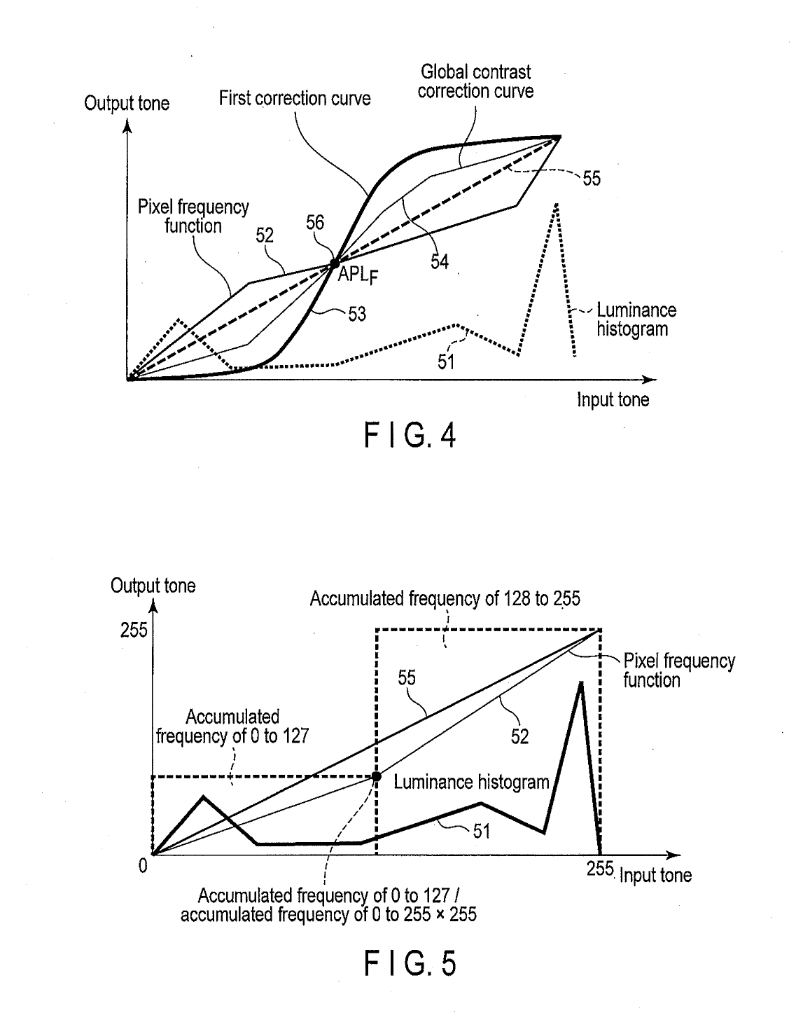

FIG. 4 shows an example of the global contrast correction curve.

The global contrast correction curve generator 34 calculates a global contrast correction curve 54 by blending a first correction curve 53, which is set with the frame average luminance value APL_{F} as an inflection point 56, and a pixel frequency function 52 at a predetermined ratio (a blending parameter λ in this case), for example, using:

Global contrast correction curve=λ×pixel frequency function+(1−λ)×first correction curve.

The blending parameter λ is, for example, 0.5, and is included in the parameters 109A stored in the HDD 109. Note that the global contrast correction curve generator 34 calculates a linear function 55 which yields “input luminance value=output luminance value” when the global contrast correction curve 54 is set not to provide any contrast correction effect.

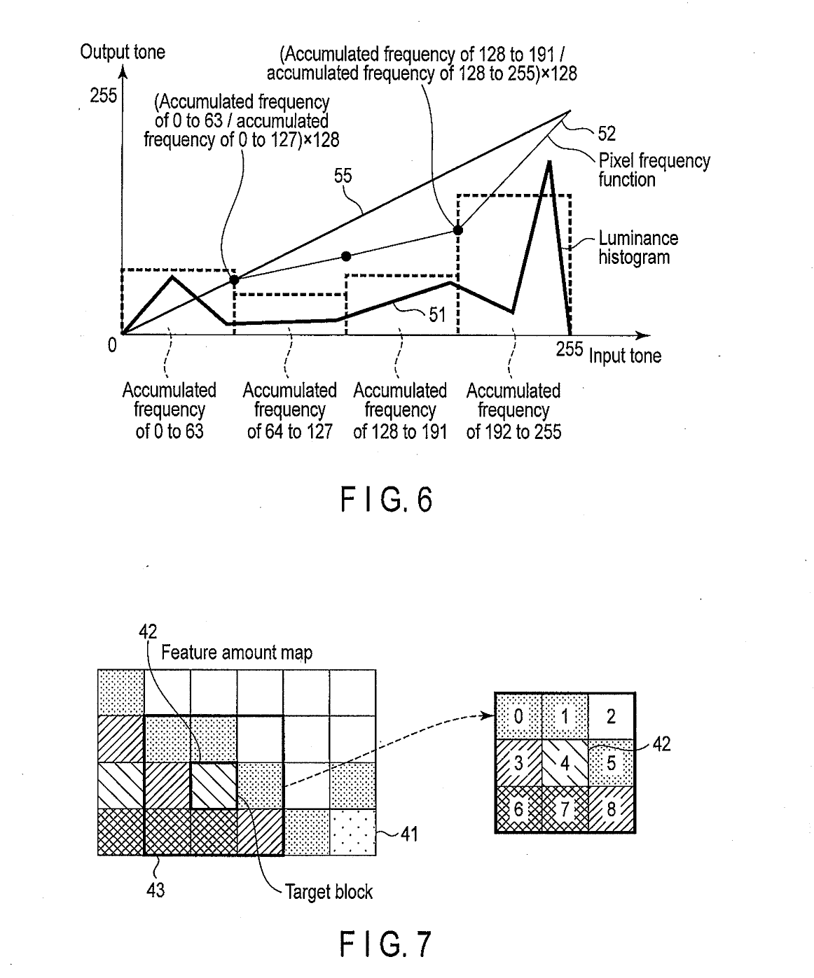

The global contrast correction curve generator 34 generates the pixel frequency function 52 based on a luminance histogram 51, as described above. FIGS. 5 and 6 show examples of the pixel frequency function 52 used to generate the global contrast correction curve. The pixel frequency function 52 is a function indicating correspondence between input tone values (to be also referred to as input luminance values hereinafter) and output tone values (to be also referred to as output luminance values hereinafter). The input and output tone values can assure values ranging from, for example, 0 to 255.

In the example shown in FIG. 5, the input tone value range is divided into two ranges (for example, a first range from 0 to 127 and a second range from 128 to 255), and accumulated frequencies corresponding to these two ranges are calculated. That is, the global contrast correction curve generator 34 calculates the number of pixels having tone values ranging from 0 to 127 (to be also referred to as a first accumulated frequency hereinafter) and the number of pixels having tone values ranging from 128 to 255 (to be also referred to as a second accumulated frequency hereinafter) in the target frame. Then, the global contrast correction curve generator 34 decides output tone value ranges to be respectively assigned to the two ranges in accordance with the calculated first and second accumulated frequencies. The global contrast correction curve generator 34 calculates a boundary value of output tone values to be respectively assigned to the two ranges, for example, using:

Boundary value=first accumulated frequency/(first accumulated frequency+second accumulated frequency)×255.

That is, the global contrast correction curve generator 34 assigns a narrow output tone value range to an input tone value range with the small accumulated frequency, and assigns a broad output tone value range to an input tone value, range with the large accumulated frequency in accordance with a ratio between the first and second accumulated frequencies. More specifically, the global contrast correction curve generator 34 calculates a polygonal-line-like pixel frequency function 52, which assigns an output tone value range from 0 to the boundary value to the first range, and assigns an output tone value range from the boundary value to 255 to the second range. In this way, since the pixel frequency function 52 is calculated to assign an input tone value range including the larger number of pixels to a broader output tone value range, the contrast correction effect applied to pixels which belong to the input tone value range including the larger number of pixels can be enhanced.

In the example shown in FIG. 6, the input tone value ranges in the example shown in FIG. 5 are further divided to similarly decide output tone value ranges to be respectively assigned to the four-divided input tone value ranges. The global contrast correction curve generator 34 calculates accumulated frequencies of the four-divided input tone value ranges, and calculates boundary values of output tone value ranges using the calculated accumulated frequencies. Thus, the global contrast correction curve generator 34 can calculate a pixel frequency function 52 corresponding to the accumulated frequencies of the four-divided input tone value ranges.

Like in the examples shown in FIGS. 5 and 6, as the input tone value range is divided finer, the pixel frequency function 52 which matches changes of the numbers of pixels in the luminance histogram can be calculated.

With the above processing, the global contrast correction curve generator 34 can generate the global contrast correction curve 54 according to the feature amounts of the target frame by blending this pixel frequency function 52 and the first correction curve 53 adjusted based on the frame average luminance value APL_{F}. Using the global contrast correction curve 54, the contrast correction according to the target frame can be applied to pixels in that frame. However, the contrast correction based on the global contrast correction curve 54 may often cause deterioration of image quality. For example, when contrast enhancement correction is applied to a region where luminance values change smoothly (a small region in a video frame), these luminance value changes are drawn like contours, thus generating pseudo-edges. That is, if very small luminance value changes in a certain region are converted into large luminance value changes by the contrast correction, image quality of the region including smooth luminance value changes may deteriorate. Also, for example, noise included in a flat region where luminance values do not almost change may be further emphasized more. For this reason, in this embodiment, the block feature amount calculator 35 and local contrast correction curve generator 36 generate local contrast correction curves according to respective feature amounts of blocks set by dividing the target frame as follows.

The block feature amount calculator 35 divides the target frame output from the video frame reader 31 into blocks each having a predetermined size (for example, 16 pixels×16 pixels). Then, the block feature amount calculator 35 sets a first block (for example, a block located at the upper left end of the target frame) as a target block. The block feature amount calculator 35 sets blocks in the target frame as a target block in turn from, for example, a block located at the upper left end in the frame to that located at the lower right end in the frame.

The block feature amount calculator 35 detects maximum and minimum luminance values of luminance values of pixels in the target block, and calculates a difference VAR between these maximum and minimum luminance values. This difference VAR is related to a flatness of luminance values in the target block. That is, when a luminance value change in the target block is small (that is, when the flatness is high), the difference VAR assumes a small value; when a luminance value change in the target block is large (that is, when the flatness is low), it assumes a large value. Also, the block feature amount calculator 35 calculates an average luminance value (block average luminance value) APL_{B} of pixels×ⱼ included in the target block using:

$${APL}_{B} = \frac{1}{M} {\sum }_{j = 0}^{M} {x}_{j} ,$$

where M is the number of pixels included in the target block. The block feature amount calculator 35 outputs the calculated difference VAR and block average luminance value APL_{B} to the local contrast correction curve generator 36.

Note that the block feature amount calculator 35 may calculate feature amounts of the target block using the target block and neighboring blocks of the target block.

FIG. 7 shows an example of a target block 42 (number 4) and neighboring blocks 43 (numbers 0 to 3 and 5 to 8) of the target block. In the example shown in FIG. 7, assume that the differences VAR and block average luminance values APL_{B} for the target block 42 and neighboring blocks 43 have already been calculated. A feature amount map 41 shows feature amounts (for example, differences VAR, block average luminance values APL_{B}, and the like) corresponding to blocks in the target frame.

The block feature amount calculator 35 calculates, as a feature amount corresponding to the target block 42, a sum of absolute difference VAR_{D} using differences VARₖ corresponding to the target block 42 and the neighboring blocks 43, as given by, for example, the following equation. That is, the block feature amount calculator 35 calculates a summation of absolute values of differences between a difference VAR₄ corresponding to the target block 42 and differences VARₖ (k=0 to 3, 5 to 8) respectively corresponding to the neighboring blocks 43. Note that k corresponds to numerals which represent block positions shown in FIG. 7.

$${VAR}_{D} = {\sum }_{k = 0}^{8} \vert {VAR}_{k} - {VAR}_{4} \vert$$

Alternatively, the block feature amount calculator 35 may calculate, as a feature amount corresponding to the target block 42, a sum of absolute difference APL_{D} of the block average luminance values APL_{B} using block average luminance values APL_{Bk} respectively corresponding to the neighboring blocks 43 of the target block 42, as given by the following equation. That is, the block feature amount calculator 35 calculates a summation of absolute values of differences between a block average luminance value APL_{B4} corresponding to the target block 42 and block average luminance values APL_{Bk} (k=0 to 3, 5 to 8) respectively corresponding to the neighboring blocks 43.

$${APL}_{D} = {\sum }_{k = 0}^{8} \vert {APL}_{Bk} - {APL}_{B 4} \vert$$

The block feature amount calculator 35 outputs the calculated sum of absolute difference VAR_{D} of the differences VAR and the calculated sum of absolute difference APL_{D} of the block average luminance values APL_{B} to the local contrast correction curve generator 36.

The local contrast correction curve generator 36 generates a local contrast correction curve corresponding to the target block using the difference VAR and block average luminance value APL_{B} (or the sum of absolute difference VAR_{D} of the differences VAR and the sum of absolute difference APL_{D} of the block average luminance values APL_{B}), which are output from the block feature amount calculator 35, and the parameters 109A stored in the HDD 109.

More specifically, the local contrast correction curve generator 36 calculates an amplitude to be set for a second correction curve, which is specified by the parameters 109A, based on, for example, the difference VAR. This second correction curve is, for example, an S-shaped curve to weaken contrasts of pixels with low luminance values and to strengthen contrasts of pixels with high luminance values. In the amplitude, for example, a small value (for example, 0) is set if the difference VAR is less than a first threshold, and a value which increases in proportion to an increase in difference VAR is set if the difference VAR is greater than or equal to the first threshold.

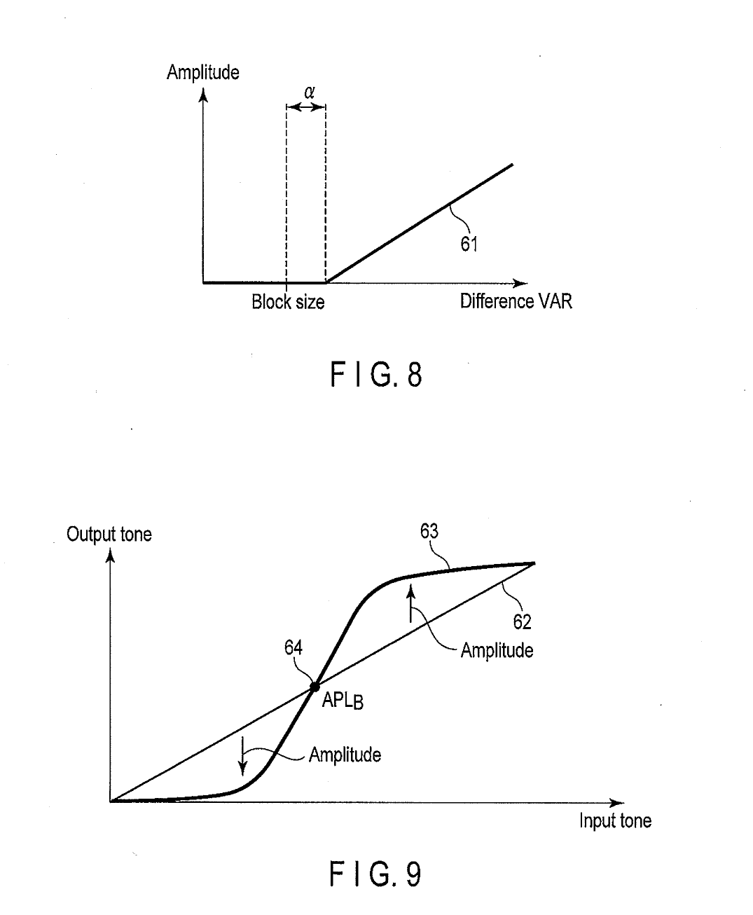

FIG. 8 shows an example of the relationship between the difference VAR and amplitude. In the example shown in FIG. 8, if the difference VAR is less than the first threshold, the amplitude is set to be zero. The first threshold is calculated, for example, by adding a predetermined value α to a block size (that is, the number of pixels in a block). Then, if the difference VAR is greater than or equal to the first threshold, a value which increases in proportion to an increase in difference VAR is set in the amplitude. That is, if the difference VAR corresponding to a block is small, since it is estimated that the block is a flat region with a small luminance value change, the amplitude is set to reduce the contrast correction effect. On the other hand, if the difference VAR corresponding to a block is large, since it is estimated that the block is not a flat region, the amplitude is set to enhance the contrast correction effect. The predetermined value α is set according to a noise amount included in the video data 109B. That is, when a noise amount is small, a small value is set; when it is large, a large value is set. This is because the difference VAR may become large due to noise. A noise amount in the video is estimated based on, for example, a bit rate of the video data 109B and an accumulated inter-frame difference of luminance values. As the accumulated inter-frame difference of luminance value assumes a larger value, it is estimated that a noise amount in the video is larger. On the other hand, as the difference assumes a smaller value, it is estimated that a noise amount in the video is smaller.

The local contrast correction curve generator 36 adjusts the second correction curve based on the calculated amplitude and block average luminance value APL_{B}. The local contrast correction curve generator 36 sets the second correction curve, in which the block average luminance value APL_{B} is set as an inflection point 64 and which has the calculated amplitude, as a local contrast correction curve 63 corresponding to the target block, as shown in FIG. 9. Therefore, if the difference VAR is greater than or equal to the first threshold, since the amplitude increases in proportion to an increase in difference VAR, the local contrast correction curve 63, which enhances the contrast correction effect in proportion to the magnitude of the difference VAR, is generated. If the difference VAR is less than the first threshold (for example, if the target block is a flat region), since the amplitude is zero, a linear function 62, which yields “input luminance value=output luminance value”, is generated as the local contrast correction curve 63. This linear function 62 does not provide any contrast correction effect since it does not change luminance values of pixels, and an original image (input video frame) is held.

On the other hand, when the local contrast correction curve corresponding to the target block is generated using the sum of absolute difference VAR_{D} of the differences VAR and the sum of absolute difference APL_{D} of the block average luminance values APL_{B}, which are output from the block feature amount calculator 35, the local contrast correction curve generator 36 generates the local contrast correction curve 63 as follows. Initially, for example, if the sum of absolute difference VAR_{D} is less than a second threshold and the sum of absolute difference APL_{D} is less than a third threshold, the local contrast correction curve generator 36 determines that the target block is a block in which pseudo-edges are readily generated since it is a flat region and is similar to surrounding blocks. Then, if the target block is the block in which pseudo-edges are readily generated, the local contrast correction curve generator 36 sets a contrast correction curve having a weak contrast correction effect as the local contrast correction curve 63 corresponding to that block. On the other hand, for example, when the sum of absolute difference VAR_{D} is greater than or equal to the second threshold, or the sum of absolute difference APL_{D} is greater than or equal to the third threshold, the local contrast correction curve generator 36 determines that the target block is a block in which pseudo-edges are hardly generated. Then, if the target block is a block in which pseudo-edges are hardly generated, the local contrast correction curve generator 36 sets a contrast correction curve having a strong contrast correction effect as the local contrast correction curve 63 corresponding to that block.

With the above processing, the local contrast correction curve generator 36 can generate the local contrast correction curve 63 according to the feature amounts of the target block. The local contrast correction curve generator 36 similarly generates local contrast correction curves 63 corresponding to other blocks in the target frame. Note that the local contrast correction curve generator 36 may control the local contrast correction curve 63 so that a change amount in a time axis direction falls within a predetermined value range. In this case, the local contrast correction curve generator 36 detects, for example, a block in the immediately preceding frame, which is located at the same position as the target block, and changes the local contrast correction curve 63 corresponding to the target block, so that a change amount between the local contrast correction curve corresponding to the block in the immediately preceding frame and the local contrast correction curve 63 corresponding to the target block falls within the predetermined value range. Thus, flickering of video frames in the time axis direction can be suppressed. The local contrast correction curve generator 36 outputs the generated local contrast correction curve 63 to the correction curve blending module 37.

The correction curve blending module 37 calculates a third contrast correction curve (blended contrast correction curve) corresponding to the target block by blending (α-blending) the global contrast correction curve 54 output from the global contrast correction curve generator 34 and the local contrast correction curve 63 output from the local contrast correction curve generator 36 at a predetermined ratio. The correction curve blending module 37 outputs the calculated third contrast correction curve to the contrast correction module 38.

The contrast correction module 38 corrects luminance values of pixels in the target frame using the third contrast correction curves output from the correction curve blending module 37. The contrast correction module 38 calculates output luminance values corresponding to luminance values (input luminance values) of pixels in the target frame using the third contrast correction curves. Then, the contrast correction module 38 sets the calculated output luminance values as new luminance values of the pixels in the target frame. The contrast correction module 38 outputs the frame including the new luminance values (that is, corrected luminance values) to the display controller 39.

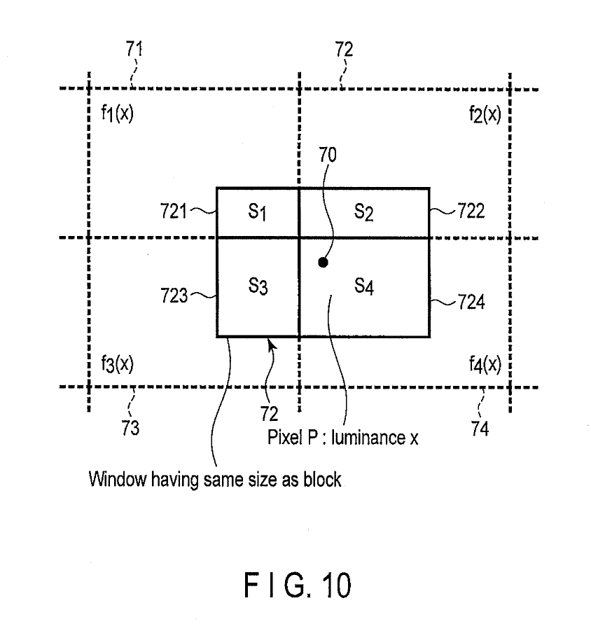

Note that, as shown in FIG. 10, the contrast correction module 38 may correct a target pixel 70 using not only a contrast correction curve f₄(x) corresponding to a block 74 including the target pixel 70 (luminance value x) but also contrast correction curves corresponding to surrounding (neighboring) blocks 71, 72, and 73.

More specifically, the contrast correction module 38 detects blocks 71, 72, 73, and 74 having regions 721, 722, 723, and 724, which overlap a window 72 having the target pixel 70 as the center. This window 72 has the same size as a block. The contrast correction module 38 detects contrast correction curves f₁(x), f₂(x), f₃(x), and f₄(x) corresponding to the detected blocks 71, 72, 73, and 74. Then, the contrast correction module 38 calculates a contrast correction curve F(x) obtained by weighting and adding these curves using weights aᵢ (i=1 to 4) according to areas (that is, the numbers of pixels in the regions) S₁, S₂, S₃, and S₄ of the regions 721, 722, 723, and 724, which overlap the window 72 using:

F(x)=a₁×f₁(x)+a₂×f₂(x)+a₃×f₃(x)+a₄×f₄(x),

aᵢ=Sᵢ/(S₁+S₂+S₃+S₄).

The contrast correction module 38 calculates an output luminance value corresponding to a luminance value (input luminance value) of the target pixel 70 using the calculated contrast correction curve F(x). Then, the contrast correction module 38 sets the calculated output luminance value as a new luminance value of the target pixel 70. Since the contrast correction curves corresponding to the surrounding blocks are also used, the contrast of the target video frame can be corrected so that smooth luminance value changes can be obtained between blocks (without generating any boundaries between blocks). Note that in the aforementioned method, by calculating the weights aᵢ in advance for respective pixels, a computation volume can be reduced, and a time required for contrast correction processing can be shortened.

The display controller 39 controls to display the video frame, which is output from the contrast correction module 38 and includes the corrected luminance values, on the screen (LCD) 17.

With the aforementioned arrangement, deterioration of image quality caused by contrast correction of an image can be suppressed. The global contrast correction curve generator 34 generates a global contrast correction curve 54 which considers features of a target frame, and the local contrast correction curve generator 36 generates local contrast correction curves 63 which consider features of blocks in the target frame. The contrast correction module 38 executes image contrast correction using the third contrast correction curves obtained by blending the global contrast correction curve 54 and local contrast correction curves 63 in consideration of not only the features of the overall frame but also those for respective blocks. Since the local contrast correction curve 63 is set not to excessively emphasize contrasts in a block having a small luminance value change (flat region), generation of pseudo-edges can be suppressed in that block. Note that the contrast correction module 38 may correct contrasts of pixels in the target block using the local contrast correction curve 63.

The block feature amount calculator 35 may calculate, as feature amounts of a target block, a gradient (a magnitude of the gradient) of luminance values of pixels in that block and a gradient direction. More specifically, the block feature amount calculator 35 calculates, using luminance values of pixels located at four corners of the target block, gradients in a horizontal direction, vertical direction, and oblique directions (that is, differences of the luminance values of the pixels located at the four corners). Also, the block feature amount calculator 35 detects a gradient direction based on the calculated gradients. The block feature amount calculator 35 detects, for example, a direction corresponding to the largest magnitude of the gradient as the gradient direction. When a target block has a small magnitude of a gradient and a gradient direction similar to neighboring blocks, the local contrast correction curve generator 36 estimates that the target block is a block including luminance values which change smoothly (a smooth gradation), and sets the linear function 62 which yields “input luminance value=output luminance value” as the local contrast correction curve 63. More specifically, when a maximum value of the magnitudes of the calculated gradients is less than a fourth threshold, and a similarity (for example, an inner product) between the detected gradient direction and those of neighboring blocks is greater than or equal to a fifth threshold, the local contrast correction curve generator 36 sets the linear function 62 as the local contrast correction curve 63. Since a flatness for each block is reflected even to the local contrast correction curve 63, which is generated based on the gradient, pseudo-edges generated by image contrast correction can be suppressed.

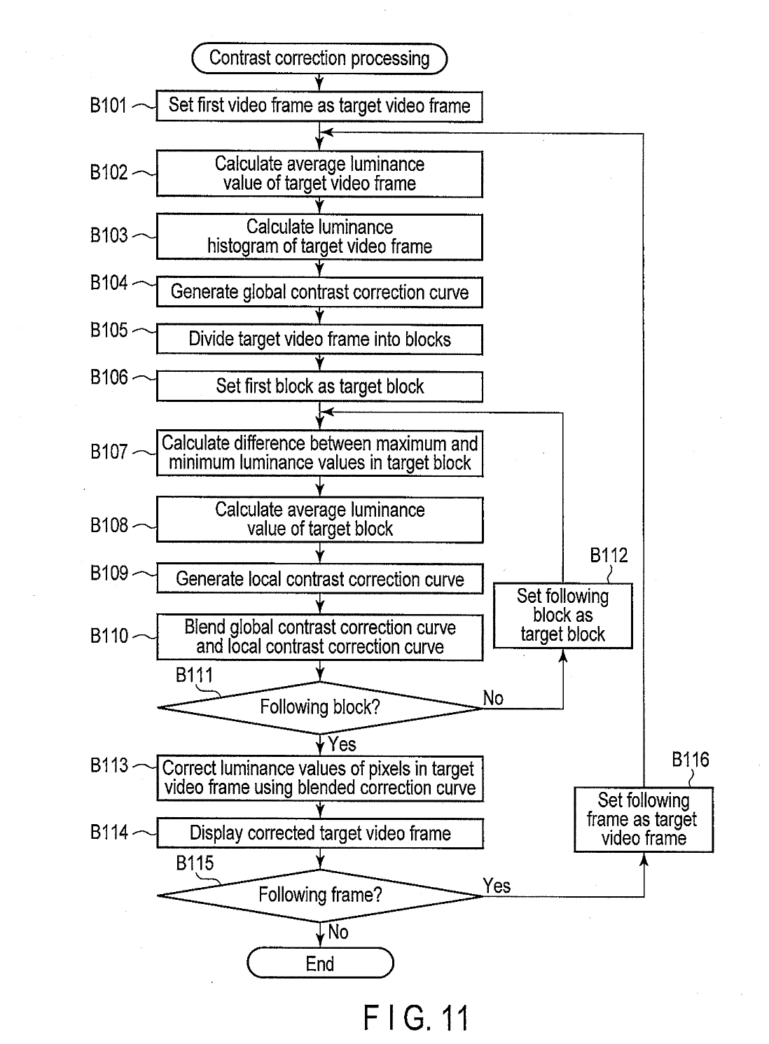

An example of the procedures of the contrast correction processing executed by the electronic apparatus 10 will be described below with reference to the flowchart shown in FIG. 11.

The video frame reader 31 reads video data 109B stored in the HDD 109 or the like, and sets a first video frame of video frames in the video data 109B as a target video frame (block B101).

Next, the frame feature amount calculator 32 calculates an average luminance value (frame average luminance value) APL_{F} of pixels in the target frame (block B102). The histogram calculator 33 calculates a luminance histogram based on luminance values of the pixels in the video target frame (block B103). The global contrast correction curve generator 34 generates a global contrast correction curve 54 corresponding to the target frame using the calculated frame average luminance value APL_{F}, the calculated luminance histogram, and the parameters 109A stored in the HDD 109 (block B104). More specifically, the global contrast correction curve generator 34 sets the calculated frame average luminance value APL_{F} as an inflection point 56 of a first correction curve 53, which is specified by the parameters 109A. The global contrast correction curve generator 34 calculates a pixel frequency function 52 based on the calculated histogram. Then, the global contrast correction curve generator 34 generates the global contrast correction curve 54 by blending the first correction curve 53, which is set with the frame average luminance value APL_{F} as the inflection point 56, and the pixel frequency function 52 at a predetermined ratio.

Next, the block feature amount calculator 35 divides the target frame into blocks each having a predetermined size (for example, 16 pixels×16 pixels) (block B105). Then, the block feature amount calculator 35 sets a first block (for example, a block located at the upper left end in the target frame) as a target block (block B106). The block feature amount calculator 35 sets blocks in the target frame as a target block in turn from the block located at the upper left end in the frame to that located at the lower right end in the frame.

The block feature amount calculator 35 detects maximum and minimum luminance values of luminance values of pixels in the target block, and calculates a difference VAR between these maximum and minimum luminance values (block B107). The block feature amount calculator 35 calculates an average luminance value (block average luminance value) APL_{B} of pixels in the target block (block B108). Then, the local contrast correction curve generator 36 generates a local contrast correction curve 63 corresponding to the target block using the calculated difference VAR, the calculated block average luminance value APL_{B}, and the parameters 109A stored in the HDD 109 (block B109). More specifically, the local contrast correction curve generator 36 calculates an amplitude to be set for a second correction curve specified by the parameters 109A based on the calculated difference VAR. The local contrast correction curve generator 36 adjusts the second correction curve based on the calculated amplitude and block average luminance value APL_{B}. The local contrast correction curve generator 36 sets the second correction curve, which is set with the block average luminance value APL_{B} as an inflection point 64 and has the calculated amplitude, as the local contrast correction curve 63 corresponding to the target block.

Then, the correction curve blending module 37 calculates a third contrast correction curve (blended contrast correction curve) corresponding to the target block by blending the global contrast correction curve 54 corresponding to the target frame and the local contrast correction curve 63 corresponding to the target block at a predetermined ratio (block B110).

Next, the block feature amount calculator 35 determines whether the target frame includes a block which follows the target block (block B111). If the following block is included (YES in block B111), the block feature amount calculator 35 sets that following block as a new target block (block B112). By returning to block B107, a third contrast correction curve corresponding to the newly set target block is calculated.

If no following block is included (that is, if third contrast correction curves corresponding to all blocks in the target frame are calculated) (NO in block B111), the contrast correction module 38 corrects luminance values of pixels in the target frame using the calculated third contrast correction curves for respective blocks (block B113). Then, the display controller 39 displays the target frame including the corrected pixels on the screen (LCD) 17 (block B114).

The video frame reader 31 then determines whether there is a frame which follows the target frame (block B115). If the following frame is found (YES in block B115), the video frame reader 31 sets that following frame as a new target frame (block B116). Then, the process returns to block B102 to correct the contrast of the newly set target frame.

If no following frame is found (NO in block B115), the processing ends.

Note that in the aforementioned processing, the case has been exemplified wherein luminance values of pixels in a video frame are corrected using the third contrast correction curves obtained by blending the global contrast correction curve 54 and local contrast correction curves 63. Alternatively, luminance values of pixels in a video frame may be corrected using the local contrast correction curves 63. Using the local contrast correction curves 63, the contrast of a video frame can be corrected while suppressing generation of pseudo-edges.

As described above, according to this embodiment, deterioration of image quality caused by image contrast correction can be suppressed. The global contrast correction curve generator 34 generates a global contrast correction curve 54 which considers the features of a target frame, and the local contrast correction curve generator 36 generates local contrast correction curves 63 which consider features of blocks in the target frame. The contrast correction module 38 corrects the contrast of video frames using third contrast correction curves obtained by blending the global contrast correction curve 54 and local contrast correction curves 63 in consideration of not only the features of the overall frame but also local features for respective blocks. Since the local contrast correction curve 63 is set to reduce the contrast correction effect for a block having a small luminance value change, generation of pseudo-edges in that block can be suppressed.

Note that the sequence of the contrast correction processing of this embodiment can be fully implemented by software. For this reason, by only installing and executing a program required to implement the sequence of the contrast correction processing via a computer-readable storage medium storing that program, the same effects as in this embodiment can be easily attained.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a block-feature amount calculator configured to divide pixels in a video frame into blocks and to calculate block-feature amounts corresponding to the blocks using luminance values of pixels in each of the blocks;
a local-contrast correction-curve generator configured to generate local-contrast correction curves corresponding to the blocks using the calculated block-feature amounts; and
a contrast-correction module configured to generate a corrected video frame by correcting luminance values of the pixels in the video frame using the generated local-contrast correction curves.

2. The apparatus of claim 1, wherein the block-feature amount calculator is configured to detect a maximum value and a minimum value of the luminance values of the pixels in each of the blocks, and wherein the block-feature amount calculator is further configured to calculate a difference between the maximum value and the minimum value, and
wherein the local-contrast correction-curve generator is configured to generate the local-contrast correction curve corresponding to a first block of the blocks using the calculated difference corresponding to the first block.

3. The apparatus of claim 2, wherein the local-contrast correction curve generator is configured to generate the local-contrast correction curve which does not change luminance values of pixels in the first block if the calculated difference corresponding to the first block is less than a threshold.

4. The apparatus of claim 2, wherein the local-contrast correction curve generator is configured to generate the local-contrast correction curve which enhances a contrast correction effect in proportion to a magnitude of the calculated difference corresponding to the first block if the difference is equal to or more than a threshold.

5. The apparatus of claim 2, wherein the block-feature amount calculator is configured to calculate, using the calculated difference corresponding to the first block and the calculated differences corresponding to second blocks which neighbor the first block, a sum of absolute differences between each of the calculated differences corresponding to the second blocks and the calculated difference corresponding to the first block, and
the local-contrast correction curve generator is configured to generate the local contrast correction curve corresponding to the first block using the calculated sum of absolute differences.

6. The apparatus of claim 1, wherein the block-feature amount calculator is configured to calculate an average of luminance values of pixels in each of the blocks, to detect a maximum value and a minimum value of the luminance values of the pixels in each of the blocks, and to calculate a difference between the maximum value and the minimum value, and
the local-contrast correction curve generator is configured to generate the local contrast correction curve corresponding to a first block of the blocks using the average and the calculated difference corresponding to the first block.

7. The apparatus of claim 1, wherein the contrast-correction module is configured to correct a luminance value of a first pixel in a first block of the blocks using the local-contrast correction curve corresponding to the first block and the local contrast correction curves corresponding to second blocks which neighbor the first block.

8. The apparatus of claim 1, further comprising a display controller configured to display the corrected video frame on a screen.

9. The apparatus of claim 1, further comprising:
a frame-feature amount calculator configured to calculate a frame-feature amount corresponding to the video frame using luminance values of the pixels in the video frame; and
a global-contrast correction curve generator configured to generate a global-contrast correction curve corresponding to the video frame using the frame-feature amount,
wherein the contrast-correction module is configured to generate the corrected video frame by correcting the luminance values of the pixels in the video frame using the local-contrast correction curves and the global-contrast correction curve.

10. A video processing method comprising:
dividing pixels in a video frame into blocks and calculating feature amounts corresponding to the blocks using luminance values of pixels in each of the blocks;
generating local-contrast correction curves corresponding to the blocks using the calculated feature amounts; and
correcting luminance values of the pixels in the video frame using the generated local-contrast correction curves.

11. A computer-readable, non-transitory storage medium having stored thereon a program which is executable by a computer, the program controlling the computer to execute functions of:
dividing pixels in a video frame into blocks and calculating feature amounts corresponding to the blocks using luminance values of pixels in each of the blocks;
generating local-contrast correction curves corresponding to the blocks using the calculated feature amounts; and
correcting luminance values of the pixels in the video frame using the generated local-contrast correction curves.
